(19) United States
(12) Patent Application Publication
(10) Pub. No.: US 2015/0155725 A1
(43) Pub. Date: Jun. 4, 2015

(54) COMPUTER MOUSE HAVING POWER GENERATION FUNCTION UTILIZING TEMPERATURE DIFFERENCE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: CHUAN WANG, Shenzhen (CN)

(21) Appl. No.: 14/494,111

(22) Filed: Sep. 23, 2014

(30) Foreign Application Priority Data
Nov. 30, 2013 (CN) 2013106218161

(51) Int. Cl. H02J 7/00

(52) U.S. Cl. CPC H02J 7/0042

(57) ABSTRACT

The present disclosure provides a computer mouse. The computer mouse includes a housing, a battery arranged in the housing, a processor, a power generation unit, and a power control circuit. The power generation unit is affixed on the inner surface of the housing, and is used for utilizing the temperature difference to generate electricity. The power control circuit connects the power generation unit and the battery, and is configured for receiving the generated electricity and converting the voltage to a proper voltage for charging the battery.

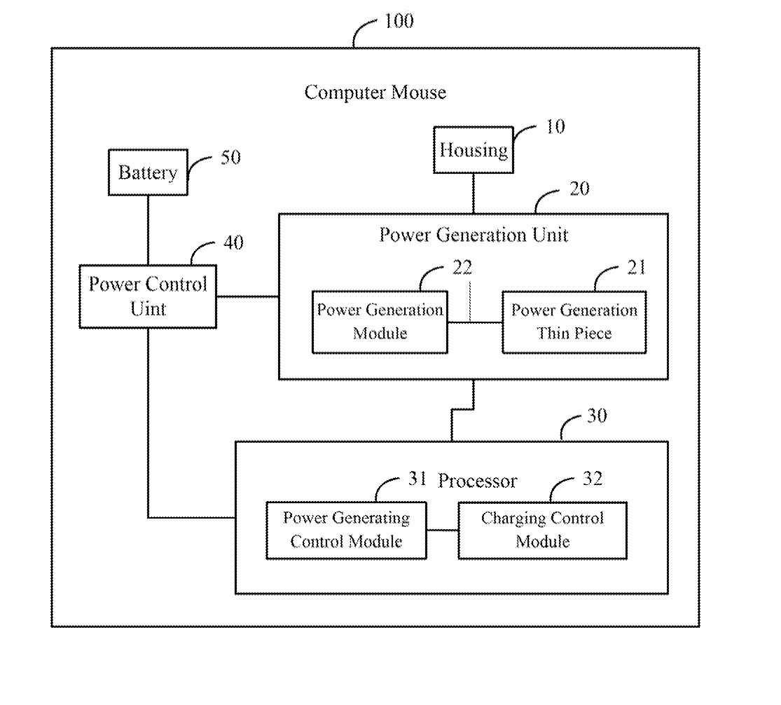

### FIELD

The present disclosure relates to a computer mouse having a power generation function, and particularly to a mouse having a power generation function which utilizes temperature difference.

### BACKGROUND

A mouse is used for inputting information to an electronic device. A mouse can be connected to the electronic devices via cables to obtain power supply. Another mouse can be wirelessly connected to the electronic devices, and includes built-in batteries for a power supply.

### BRIEF DESCRIPTION OF THE DRAWING

The components in the drawing is not necessarily drawn to scale, the emphasis instead being placed upon clearly illustrating the principles of the present disclosure.

The FIGURE illustrates a block diagram of a computer mouse having a power generation function in accordance with an exemplary embodiment.

### DETAILED DESCRIPTION

The FIGURE illustrates an exemplary embodiment of a disclosure of a computer mouse 100. The computer mouse 100 can be a wireless mouse and can include a housing 10, a power generation unit 20, a processor 30, a power control circuit 40, and a battery 50 arranged in the housing 10. The power generation unit 20 is affixed on the inner surface of the housing 10 and can be configured for utilizing the temperature difference technology to generate electricity. The power control circuit 40 connects the power generation unit 20 to the battery 50, and can be configured for receiving the generated electricity and converting the voltage of the electricity to a proper voltage for charging the battery 50.

In at least one embodiment, the power generation unit 20 can include a power generation thin piece 21 (hereinafter thin piece 21) and a power generation module 22. One surface of the thin piece 21 is affixed on the inner surface of the housing 10, and the other surface of the thin piece 21 is connected to the power generation module 22.

The housing 10 is composed of material with high thermal conductivity. Thus, the heat emitted from a hand or other portions of a human body holding the computer mouse 100 can be effectively conducted to the thin piece 21. The power generation module 22 utilizes the temperature difference between the two surfaces of the thin piece 21 to generate electricity.

The power control circuit 40 is connected between the power generation unit 20 and the battery 50. The power control circuit 40 can be used for converting the voltage of the electricity generated by the power generation unit 20 to a proper voltage, and charging the battery 50 with the converted voltage. In detail, the power control circuit 40 is connected between the power generation module 22 of the power generation unit 20 and the battery 50, and can be used for converting the voltage of the electricity generated by the power generation module 22 to a proper voltage, and charging the battery 50 with the converted voltage

The processor 30 can include a power generating control module 31 and a charging control module 32. The power generating control module 31 is configured to control the power generation module 22 to work or stop working according to the temperature data of the two surfaces of the thin piece 21. In at least one embodiment, when the power generating control module 31 determines that the difference value between the temperature values of the two surfaces of the thin piece 21 receives a predefined temperature value according to the temperature data of the two surfaces of the thin piece 21, the power generating control module 31 controls the power generation module 22 to generate electricity,. The power generation module 22 is controlled to stop generating electricity when the power generating control module 31 determines that the difference value between the temperature values of the two surfaces of the thin piece 21 is lower than the predefined temperature value according to the temperature data of the two surfaces of the thin piece 21.

When the power generation module 22 is working, the charging control module 32 controls the power control circuit 40 to convert the voltage of the electricity generated by the power generation module 22 to a proper voltage, and uses the converted voltage to charge the battery 50. In at least one embodiment, the charging control module 32 determines whether the power generation module 22 is working based on the control of the power generating control module 31.

In an alternative embodiment, the power control circuit 40 connects the power generation unit 20 to one or more power consuming members of the computer mouse 100. The power control circuit 40 can be used for converting the voltage of the electricity to a proper voltage, and supplying the converted voltage to the one or more power consuming members of the computer mouse 100. The one or more power consuming members can be infrared sensing modules and/or wireless signal transmitting and receiving modules.

With such a configuration as described, the heat emitted from the hand or other portions of the human body is effectively utilized for generating electricity, thus, capable of supplying power to the computer mouse 100 or other power consuming members of the computer mouse 100. Additionally, the electricity generated by the power generation unit 20 using the heat is saved in the battery 50, to extend service time between charging periods.

Although the present disclosure has been specifically described on the basis of the embodiments thereof, the disclosure is not to be construed as being limited thereto. Various changes or modifications may be made to the embodiments without departing from the scope of the disclosure or the scope of the following claim.

What is claimed is:

1. A computer mouse comprising:
a housing;
a battery arranged in the housing;
a processor;
a power generation unit affixed on an inner surface of the housing, configured for utilizing temperature difference to generate electricity; and
a power control circuit connecting the power generation unit to the battery, and configured for converting a voltage of the generated electricity to a proper voltage for charging the battery under the control of the processor.

2. The computer mouse as described in claim 1, wherein the power generation unit comprises a thin piece and a power generation module; one surface of the thin piece is affixed on the inner surface of the housing, and the other surface of the thin piece is connected to the power generation module; and the power generation module is configured for utilizing temperature difference between the two surfaces of the thin piece to generate the electricity.

3. The computer mouse as described in claim 2, wherein the housing is composed of material with high thermal conductivity, and is configured for conducting the heat emitted from a hand or other portions of a human body holding the housing to the thin piece.

4. The computer mouse as described in claim 1, wherein the processor comprises:
a power generating control module, configured to control the power generation module to work or stop working according to temperature data of the two surfaces of the thin piece; and
a charging control module, configured to control the power control circuit to convert the voltage of the electricity generated to a proper voltage, and to charge the converted voltage to the battery when the power generation module is working.

5. The computer mouse as described in claim 4, wherein when the power generating control module determines that the difference value between the temperature values of the two surfaces of the thin piece receives a predefined temperature value according to the temperature data of the two surfaces of the thin piece, the power generating control module is configured to control the power generation module to generate electricity; and control the power generation module to stop generating electricity when the power generating control module determines that the difference value between the temperature values of the two surfaces of the thin piece is lower than the predefined temperature value according to the temperature data of the two surfaces of the thin piece.

6. The computer mouse as described in claim 1, further comprising at least one power consuming member, wherein the power control circuit also connects the power generation unit to at least one power consuming member of the computer mouse, and is configured to convert the voltage of the electricity to a proper voltage, and supply the converted voltage to the at least one power consuming member of the computer mouse under the control of the processor.

7. A computer mouse comprising:
a housing;
at least one consuming member;
a processor;
a power generation unit affixed on an inner surface of the housing, and configured for utilizing temperature difference to generate electricity; and
a power control circuit connected the power generation unit to the at least one consuming member, and configured for converting a voltage of the generated electricity to a proper voltage for supplying the at least one consuming member under the control of the processor.

8. The computer mouse as described in claim 7, wherein the power generation unit comprises a thin piece and a power generation module; one surface of the thin piece is affixed on the inner surface of the housing, and the other surface of the thin piece is connected to the power generation module; and the power generation module is configured for utilizing temperature difference between the two surfaces of the thin piece to generate the electricity.

9. The computer mouse as described in claim 8, wherein the housing is composed of material with high thermal conductivity, and is configured for conducting the heat emitted from a hand or other portions of a human body holding the housing to the thin piece.

10. The computer mouse as described in claim 7, wherein the processor comprises:
a power generating control module, configured to control the power generation module to work or stop working according to temperature data of the two surfaces of the thin piece; and
a charging control module, configured to control the power control circuit to convert the voltage of the electricity generated to a proper voltage, and to supply the converted voltage to the at least one consuming member when the power generation module is working

11. The computer mouse as described in claim 10, wherein when the power generating control module determines that the difference value between the temperature values of the two surfaces of the thin piece receives a predefined temperature value according to the temperature data of the two surfaces of the thin piece, the power generating control module is configured to control the power generation module to generate electricity; and control the power generation module to stop generating electricity when the power generating control module determines that the difference value between the temperature values of the two surfaces of the thin piece is lower than the predefined temperature value according to the temperature data of the two surfaces of the thin piece.

12. The computer mouse as described in claim 7, wherein the at least one power consuming member is selected from the group consisting of: an infrared sensing module and a wireless signal transmitting and receiving module.
